(19) United States
(12) Patent Application Publication
(10) Pub. No.: US 2012/0201986 A1
(43) Pub. Date: Aug. 9, 2012

(54) POLYESTER COMPOSITIONS WITH IMPROVED PROPERTIES

(75) Inventor: KAZUKI AKIBA, KENNETT SQUARE, PA (US)

(73) Assignee: E. I. DU PONT DE NEMOURS AND COMPANY, Wilmington, DE (US)

(21) Appl. No.: 13/369,341

(22) Filed: Feb. 9, 2012

Related U.S. Application Data
(60) Provisional application No. 61/440,959, filed on Feb. 9, 2011.

(51) Int. Cl. C08K 5/098; C08K 3/26; B32B 1/08; C08L 71/00

(52) U.S. Cl. 428/36.9; 524/80; 524/394; 524/424

(57) ABSTRACT

The recited invention relates to polyester elastomer compositions having improved mechanical properties when prepared using aqueous solutions of metal salts. An improvement in DMA storage modulus, a decrease in melt flow rate and an increase in light transmittance are observed in polyester elastomer compositions in which the metal salt is melt-mixed with aqueous solutions of metal salts compared to polyester compositions in which the metal salt is mixed into the polyester composition as a solid.

### CROSS-REFERENCE TO RELATED APPLICATION

This application claims the benefit of U.S. Provisional Application No. 61/440,959, filed Feb. 9, 2011.

### FIELD OF THE INVENTION

The invention relates to polyester elastomer compositions having improved mechanical properties, processes for manufacturing polyester compositions, and articles prepared from these compositions.

### BACKGROUND OF THE INVENTION

Polyetherester copolymer elastomers exhibit good low temperature flexibility, mechanical strength, resistance to impact, fatigue resistance, and processability. However, achieving a combination of high stiffness and low temperature flexibility simultaneously in such compositions is difficult. Methods which have been used in the past in an attempt to provide a composition having this desirable combination of properties include blending stiff polymers or inorganic fillers into the polyetherester copolymer matrix but this has not been completely satisfactory.

It is known that increasing the melt strength of polyesters may improve certain physical properties, such as processability. It is also known that addition of ionomeric polymers and salts of carboxylic acids is a method for increasing the melt strength of polyesters. For example, U.S. Pat. No. 4,010,222 discloses a polymer blend consisting essentially of a copolyester elastomer and an ethylene/carboxylic acid copolymer in which at least 10% of the acid groups are neutralized (i.e. an ionomer) thereby producing a copolyester elastomer composition having an increased melt strength. The patent teaches that such copolyester elastomer blend compositions are more processable by blow molding than polyester compositions that do not contain the ionomer.

U.S. Pat. No. 3,957,706 teaches blending polyetherester copolymers with solid particles of alkali metal carboxylic acid salts. The patent teaches that sodium salts of linear or branched saturated or unsaturated aliphatic monocarboxylic acids having 3 to 22 carbon atoms exhibit unexpected compression recovery.

U.S. Pat. No. 4,362,836 teaches the addition of alkali metal salts of aliphatic polycarboxylic acids to polyester elastomers. The alkali metal salts have at least 20 carbon atoms and two carboxyl groups.

U.S. Patent Application Publication No. US 2010/0127434 discloses the addition of rheological additives that include solid organic and inorganic salts and aqueous solutions of these materials to compositions termed “Molecularly Self-assembling Materials”, which are described as polyesteramides, copolyesteramides, copolyetheramides, copolyetherester-amides, copolyetherester-urethanes, copolyether-urethanes, copolyester-urethanes, copolyester-ureas, copolyetherester-ureas and their mixtures. The addition of the rheological additive is said to decrease melt viscosity.

U.S. Patent Application Publication No. 2007/0246867 discloses a process for introducing an additive, such as an inorganic salt or a salt of certain organic acids, such as acetic acid or propionic acid, to a polymer in the melt, wherein the additive is introduced to the molten polymer as an aqueous solution.

U.S. Provisional Patent Application No. 61/308,960 discloses processes for decreasing the melt flow rate of a polyester by melt-mixing with the polyester a solid alkali metal salt having a molecular weight less than 300.

There remains a need for polyetherester copolymer elastomer compositions that exhibit improved melt rheology at elevated temperatures while maintaining mechanical properties in the solid state. In particular, there is a need for polyetherester copolymer compositions that have melt viscosity properties that permit more efficient blow molding. There is also a need for practical processes to produce such copolyetherester compositions.

### SUMMARY OF THE INVENTION

The present invention is directed to a process for forming a moldable polyester composition comprising the steps of
A. melt-mixing a composition comprising
   1. a polyester having a Shore D hardness of 40 D or greater as determined according to ISO 868; and
   2. at least one aqueous solution comprising a metal salt having a molecular weight of 500 or less, wherein i) the metal salt comprises a group 1A cation and ii) the boiling point of the conjugate acid of the anion of the metal salt is less than 300° C.,
   thereby forming a polyester/metal salt mixture, wherein the metal salt is present in the polyester/metal salt mixture in an amount of about 0.05 weight percent to about 20 weight percent, based on the total combined weight of the metal salt and the polyester; and
B. removing water and gases from the polyester/metal salt mixture to form a moldable polyester composition.

The invention is also directed to a use of a polyester composition for molding a shaped article, the polyester composition being prepared by the process of
A. melt-mixing a composition comprising
   1. a polyester having a Shore D hardness of 40 D or greater as determined according to ISO 868; and
   2. at least one aqueous solution comprising a metal salt having a molecular weight of 500 or less, wherein i) the metal salt comprises a group 1A cation and ii) the boiling point of the conjugate acid of the anion of the metal salt is less than 300° C.,
   thereby forming a polyester/metal salt mixture, wherein the metal salt is present in the polyester/metal salt mixture in an amount of about 0.05 weight percent to about 20 weight percent, based on the total combined weight of the metal salt and the polyester; and
B. removing water and gases from the polyester/metal salt mixture to form a moldable polyester composition.

The invention is further directed to articles comprising the moldable polyester compositions prepared by the processes of the invention.

The invention is also directed to a use of a polyester composition for molding a shaped article, the polyester composition being made by the above-described melt-mixing process.

### DETAILED DESCRIPTION OF THE INVENTION

The following definitions are to be used to interpret the meaning of the terms discussed in the specification and recited in the claims.

As used herein, the article “a” indicates one as well as more than one and does not necessarily limit its referent noun to the singular.

As used herein, the terms “about” and “at or about” mean that the amount or value in question may be the value designated or some other value that is approximately the same. The phrase is intended to convey that similar values promote equivalent results or effects according to the invention.

As used herein, the term “melt-mixing” refers to the mixing of a polyester polymer with other materials at a temperature above the melting point of the polyester polymer to obtain a homogeneous mixture.

As used herein, the term “aqueous solution of a metal salt” refers to a solution comprising water and metal salts wherein the metal salts are completely dissolved in the water.

As used herein, the term “equivalent quantity” refers to the same weight of a material on a solids basis. In other words, if an aqueous solution of a metal salt contains 25% salt on a weight basis (e.g., 25 grams metal salt and 75 grams water) then 100 grams of the aqueous metal salt solution would contain an amount of metal salt which is an equivalent quantity to that of 25 grams of salt in solid form.

As used herein, the term “melt flow rate” (MFR) refers to the flow rate of a material through a capillary under controlled conditions of temperature and pressure/load. MFR is a measure of the ability of a polymer melt (i.e. a polymer above its melting temperature) to flow under pressure and is inversely proportional to the viscosity of the melt under specific test conditions. MFR is determined according to the method of International Standard ISO 1133: 1997(E).

As used herein, the term “greater” refers to a larger numerical value. For example, a value of 2 is greater than a value of 1.5.

As used herein, the term “lower” refers to a smaller numerical value. For example, a MFR of 0.5 g/10 min. is lower than a MFR of 3 g/10 min.

As used herein, the term “DMA storage modulus” refers to a storage modulus measured by Dynamic Mechanical Analysis (DMA) according to ISO 6721-5 on an injection molded test specimen, molded in a mold cavity having a length of 135.35 mm, width of 12.89 mm and depth of 3.23 mm and cut to a 60 mm length, over a frequency range selected from 1 to 20 Hz.

As used herein, the term “metal salt” refers to a salt comprising a monovalent cation selected from group 1A metals of the Periodic Table of the Elements. “At least one metal salt” means one or more metal salts such as, for example, two, three, or four metal salts.

The present invention is directed to a process for preparing polyester compositions, especially copolyetherester copolymer compositions, that have improved melt viscosity and blow molding characteristics. By using the process of the invention, wherein polyesters of specific Shore D hardness are melt-mixed with aqueous solutions of alkali metal salts of (i.e. aqueous solutions of salts comprising Group 1A metal cations) it is possible to produce polyester compositions that have markedly superior melt flow rates compared to compositions produced by melt mixing processes wherein the equivalent quantity of alkali metal salt (as defined hereinabove) in solid form is melt mixed with the polyester substrate composition under similar melt-mixing conditions. In addition, the flexural modulus, as measured by the DMA storage modulus, of the resultant polyester compositions made by the processes of the invention is typically superior to the flexural modulus of polyester compositions prepared under conditions wherein the equivalent quantity of alkali metal salt is added in solid form to the polymer melt and the resultant blend is melt-mixed. Flexural modulus represents the ratio of stress to strain in flexural deformation of a polymer. The higher the flexural modulus value, the better the ability of the polymer to resist deformation under load. Thus, an improvement in flexural modulus, as measured by DMA storage modulus, is represented by an increase in the numerical value for DMA storage modulus. For purposes of the invention, DMA storage modulus is measured according to ISO 6721-5 using the conditions described above.

Further, the light transmittance of polyester compositions prepared by melt-mixing aqueous metal salt solutions with the polymer melt according to the processes of the invention is typically superior to the light transmittance of polyester compositions prepared under conditions wherein the equivalent quantity of alkali metal salt (as defined above) in solid form is melt-mixed with the polymer.

As used herein, light transmittance is a measure of the amount of light of a specified wavelength that passes through a test specimen prepared from a polyester composition of the invention when tested according to ASTM D1003B using a CIE standard Illuminant D65 light source and a GretagMacbeth Color-Eye® 7000A spectrophotometer available from GretagMacbeth Corporation, New Windsor, N.Y., U.S.A. For purposes of this invention, light transmittance is represented as the average total transmittance (Tₜ).

The higher the average total transmittance value, the better the ability of the polymer to allow light to pass through the test specimen. Thus, an improvement in average total transmittance, as measured by ASTM D1003B using a CIE standard Illuminant D65 light source and a Macbeth Color-Eye® 7000A spectrophotometer, is represented by an increase in the numerical value for average total transmittance.

### Polyester Polymer

The process of the invention comprises melt-mixing polyester polymers with an aqueous solution of at least one alkali metal salt. Polyester polymers suitable for use in the invention are selected from the group consisting of polyesters derived from one or more dicarboxylic acids, which include esters, and one or more diols having more than two carbon atoms, copolyester thermoplastic elastomers, and mixtures of these. The polyester polymers have a Shore D hardness (i.e. a durometer hardness) of at least about 40 D, preferably at least 45 D, as determined by ISO 868. Suitable polyester polymers have number average molecular weights of greater than 10,000 g/mol, preferably greater than 15,000 g/mol, and more preferably greater than 20,000 g/mol prior to mixing with the metal salt solution. Copolyester thermoplastic elastomers (TPCs) of note include copolyesterester elastomers, copolycarbonate ester elastomers, and copolyetherester elastomers, the latter being preferred.

Copolyesterester elastomers are block copolymers containing a) hard polyester segments and b) soft and flexible polyester segments. Examples of hard polyester segments are polyalkylene terephthalates, poly(cyclohexanedicarboxylic acid cyclohexanemethanol). Examples of soft polyester segments are aliphatic polyesters, including polybutylene adipate, polytetramethyladipate and polycaprolactone. The copolyesterester elastomers contain blocks of ester units of a high melting polyester and blocks of ester units of a low melting polyester which are linked together through ester groups and/or urethane groups. Copolyesterester elastomers comprising urethane groups may be prepared by reacting the different polyesters in the molten phase, after which the resulting copolyesterester is reacted with a low molecular weight polyisocyanate, such as diphenylmethylene diisocyanate.

Copolycarbonateester elastomers are block copolymers containing a) hard segments consisting of blocks of an aromatic or semi-aromatic polyester and b) soft segments consisting of blocks of a polycarbonate containing polymeric component. Suitably, the copolycarbonateester elastomer is made of hard polyester segments made up of repeating units derived from an aromatic dicarboxylic acid and an aliphatic diol, and of soft segments made up of repeating units of an aliphatic carbonate, and/or soft segments made up of randomly distributed repeating units of an aliphatic carbonate and either an aliphatic diol and an aliphatic dicarboxylic acid or a lactone, and a combination of these, wherein the hard segments and the soft segments can be connected with a urethane group. These elastomers and their preparation are described in EP Pat. No. 0846712, for example.

Copolyetherester elastomers are preferred thermoplastic polyesters in these compositions and have a multiplicity of recurring long-chain ester units and short-chain ester units joined head-to-tail through ester linkages. The long-chain ester units are represented by formula (A):

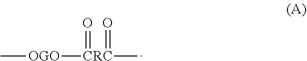

The short-chain ester units are represented by formula (B):

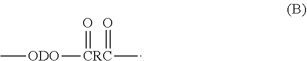

G is a divalent radical remaining after the removal of terminal hydroxyl groups from poly(alkylene oxide)glycols having a number average molecular weight of between about 400 and about 6000, or preferably between about 400 and about 3000;
R is a divalent radical remaining after removal of carboxyl groups from a dicarboxylic acid having a molecular weight of less than about 300; and
D is a divalent radical remaining after removal of hydroxyl groups from a diol having a molecular weight less than about 250.

As used herein, the term “long-chain ester units” as applied to units in a polymer chain refers to the reaction product of a long-chain glycol with a dicarboxylic acid. Suitable long-chain glycols are poly(alkylene oxide) glycols having terminal (or as nearly terminal as possible) hydroxyl groups and having a number average molecular weight of from about 400 to about 6000, and preferably from about 600 to about 3000. Preferred poly(alkylene oxide)glycols include poly(tetramethylene oxide)glycol, poly(trimethylene oxide)glycol, poly(propylene oxide)glycol, poly(ethylene oxide)glycol, copolymer glycols of these alkylene oxides, and block copolymers such as ethylene oxide-capped poly(propylene oxide)glycol. Mixtures of two or more of these can be used.

As used herein, the term “short-chain ester units” as applied to units in a polymer chain of copolyetheresters refers to low molecular weight compounds or polymer chain units having molecular weights less than about 550. These units are made by reacting a low molecular weight diol or a mixture of diols (molecular weight below about 250) with a dicarboxylic acid to form ester units represented by Formula (B) above. Included among the low molecular weight diols that react to form suitable short-chain ester units are acyclic, alicyclic and aromatic dihydroxy compounds. Preferred are diols with about 2-15 carbon atoms such as ethylene, propylene, isobutylene, tetramethylene, 1,4-pentamethylene, 2,2-dimethyltrimethylene, hexamethylene and decamethylene glycols, dihydroxycyclohexane, cyclohexane dimethanol, resorcinol, hydroquinone, 1,5-dihydroxynaphthalene, etc. Especially preferred are aliphatic diols containing 2-8 carbon atoms, and a more preferred diol is 1,4-butanediol. Included among the bisphenols which can be used are bis(p-hydroxy)diphenyl, bis(p-hydroxyphenyl)methane, and bis(p-hydroxyphenyl)propane. Equivalent ester-forming derivatives of diols are also useful.

As used herein, the term “diols” includes equivalent ester-forming derivatives such as those mentioned. However, any molecular weight requirements refer to the corresponding diols, not their derivatives.

Dicarboxylic acids that can react with the foregoing long-chain glycols and low molecular weight diols to produce the copolyetheresters are aliphatic, cycloaliphatic or aromatic dicarboxylic acids of a low molecular weight, i.e., having a molecular weight of less than about 300. The term “dicarboxylic acids” as used herein includes functional equivalents of dicarboxylic acids that have two carboxyl functional groups that perform substantially like dicarboxylic acids in reaction with glycols and diols in forming copolyetherester polymers. These equivalents include esters and ester-forming derivatives such as acid halides and anhydrides. The molecular weight requirement pertains to the acid and not to its equivalent ester or ester-forming derivative.

Thus, an ester of a dicarboxylic acid having a molecular weight greater than 300 or a functional equivalent of a dicarboxylic acid having a molecular weight greater than 300 are included provided the corresponding acid has a molecular weight below about 300. The dicarboxylic acids can contain any substituent groups or combinations that do not substantially interfere with copolyetherester polymer formation.

As used herein, the term “aliphatic dicarboxylic acids” refers to carboxylic acids having two carboxyl groups, each group attached to a saturated carbon atom. If the carbon atom to which the carboxyl group is attached is saturated and is in a ring, the acid is cycloaliphatic. Aliphatic or cycloaliphatic acids having conjugated unsaturation often cannot be used because of homopolymerization. However, some unsaturated acids, such as maleic acid, can be used.

As used herein, the term “aromatic dicarboxylic acids” refer to dicarboxylic acids having two carboxyl groups, each group attached to a carbon atom in a carbocyclic aromatic ring structure. It is not necessary that both functional carboxyl groups be attached to the same aromatic ring and where more than one ring is present, they can be joined by aliphatic or aromatic divalent radicals or divalent radicals such as —O— or —SO₂—. Representative useful aliphatic and cycloaliphatic acids that can be used include sebacic acid; 1,3-cyclohexane dicarboxylic acid; 1,4-cyclohexane dicarboxylic acid; adipic acid; glutaric acid; 4-cyclohexane-1,2-dicarboxylic acid; 2-ethylsuberic acid; cyclopentanedicarboxylic acid decahydro-1,5-naphthylene dicarboxylic acid; 4,4′-bicyclohexyl dicarboxylic acid; decahydro-2,6-naphthylene dicarboxylic acid; 4,4′-methylenebis(cyclohexyl)carboxylic acid; and 3,4-furan dicarboxylic acid. Preferred acids are cyclohexane dicarboxylic acids and adipic acid.

Representative aromatic dicarboxylic acids include phthalic, terephthalic and isophthalic acids; bibenzoic acid; substituted dicarboxy compounds with two benzene nuclei such as bis(p-carboxyphenyl)methane; p-oxy-1,5-naphthalene dicarboxylic acid; 2,6-naphthalene dicarboxylic acid; 2,7-naphthalene dicarboxylic acid; 4,4′-sulfonyl dibenzoic acid and C₁-C₁₂ alkyl and ring substitution derivatives thereof, such as halo, alkoxy, and aryl derivatives. Hydroxy acids such as p-(beta-hydroxyethoxy)benzoic acid can also be used provided an aromatic dicarboxylic acid is also used.

Aromatic dicarboxylic acids are preferred for making the copolyetherester elastomers. Among the aromatic acids, those with 8-16 carbon atoms are preferred, particularly terephthalic acid alone or with a mixture of phthalic and/or isophthalic acids.

The copolyetherester elastomer preferably comprises from 15 to 99 weight percent, more preferably 20 to 95 weight percent, and still more preferably 50 to 90 weight percent, of short-chain ester units corresponding to Formula (B), with the remainder being long-chain ester units corresponding to Formula (A) above. More preferably, at least about 70% of the groups represented by R in Formulae (A) and (B) above are 1,4-phenylene radicals and at least about 70% of the groups represented by D in Formula (B) above are 1,4-butylene radicals and the sum of the percentages of R groups which are not 1,4-phenylene radicals and D groups that are not 1,4-butylene radicals does not exceed 30%. If a second dicarboxylic acid is used to make the copolyetherester, isophthalic acid is preferred. If a second low molecular weight diol is used, ethylene glycol, 1,3-propanediol, cyclohexanedimethanol, or hexamethylene glycol are preferred.

Since a mixture of two or more copolyetherester elastomers may be used, the weight percent of short-chain ester units of each copolyetherester elastomer in the mixture need not be within the values disclosed herein. Rather, it is the total weight percent of short-chain ester units for the elastomer mixture that must fall within the values disclosed above, and is calculated as a weighted average. For example, in a mixture that contains equal amounts of two copolyetherester elastomers, one copolyetherester elastomer can contain 60 weight percent short-chain ester units and the other resin can contain 30 weight percent short-chain ester units for a weighted average of 45 weight percent short-chain ester units.

Preferably, the copolyetherester elastomers are made from esters or mixtures of esters of terephthalic acid and/or isophthalic acid, 1,4-butanediol and poly(tetramethylene ether)glycol or poly(trimethylene ether) glycol or ethylene oxide-capped polypropylene oxide glycol, or are prepared from esters of terephthalic acid, e.g. dimethylterephthalate, 1,4-butanediol and poly(ethylene oxide)glycol. More preferably, the copolyetheresters are prepared from esters of terephthalic acid, e.g. dimethylterephthalate, 1,4-butanediol and poly(tetramethylene ether)glycol.

Preferably, the polyester resins are selected from poly(trimethylene terephthalate) (PTT), poly(1,4-butylene terephthalate) (PBT), poly(ethylene 2,6-naphthoate) (PEN), and poly(1,4-cyclohexyldimethylene terephthalate) (PCT), poly(1,4-butylene terephthalate) (PBT) and copolymers and mixtures of these. More preferably the polyester resin is poly(trimethylene terephthalate) (PTT), poly(1,4-butylene terephthalate) (PBT), poly(1,4-cyclohexyldimethylene terephthalate) (PCT), and copolymers and blends of the same. Still more preferably are poly(trimethylene terephthalate) (PTT), poly(1,4-butylene terephthalate) (PBT) and copolymers and blends of the same. Examples of suitable copolyetherester elastomers are commercially available under the trademark Hytrel® from E.I. du Pont de Nemours and Company, Wilmington, Del.

### Aqueous Solutions of Metal Salts

Aqueous solutions of metal salts that are melt mixed with polyester polymers according to the process of the invention comprise both organic and inorganic salts. Suitable organic metal salts include, but are not limited to metal salts of carbonic acid, acetic acid, formic acid, benzoic acid, propionic acid, butyric acid, oxalic acid, malonic acid, glutaric acid, and maleic acid. Inorganic metal salts that may be used include, but are not limited to, metal salts such as sodium chloride, sodium bromide, sodium iodide, potassium bromide, potassium chloride, lithium bromide, lithium chloride, and potassium iodide. Salts of organic acids are preferred over inorganic metal salts.

Preferably, the organic or inorganic metal salts have molecular weights less than 500, preferably less than 300, more preferably less than 250, and most preferably less than 200.

The cations which can be used to form the metal salts useful in the practice of the invention are group 1A alkali metal cations. The monovalent group 1A cations are lithium, sodium, potassium, rubidium, and cesium with lithium, sodium and potassium being preferred. Sodium and potassium are more preferred and sodium is the most preferred cation. Divalent cations are not aspects of the invention, but mixed monovalent cation salts, for example a mixed salt of maleic acid, may be useful in certain embodiments. Preferred examples of organic monovalent metal salts of the invention include metal carbonates and metal acetates, and mixtures of these. The monovalent metal salts of the invention include the various hydrates of these salts as well as the anhydrous form of the metal salts. For example, sodium carbonate refers to a salt defined by the nominal formula Na₂CO₃.xH₂O, wherein x is greater than or equal to zero. Examples of sodium carbonate are anhydrous sodium carbonate (Na₂CO₃.0H₂O), sodium carbonate monohydrate (Na₂CO₃.1H₂O), sodium carbonate heptahydrate (Na₂CO₃.7H₂O), and sodium carbonate decahydrate (Na₂CO₃.10H₂O). Molecular weight of the metal salts useful in the practice of the invention is based on the anhydrous form (zero moles of water) of the metal salt.

Without being bound by theory, it is believed that during melt-mixing with the polyester the metal salt takes part in an ion exchange reaction with the acid end group(s) of the polyester. This converts the acid end group into an acid salt in which the cation of the metal salt becomes the cation of the polyester acid salt.

Ion exchange reactions of the metal salts with the acid end groups of the polyester result in the generation of chemical compounds, for example acids, which could adversely affect the physical properties of the polyester composition produced by the processes of the invention. It would be preferable if these undesirable compounds could be removed during the melt-mixing process. One type of undesirable compound that is formed will be the conjugate acid of the anion of the metal salt. If the molecular weight of the conjugate acid is below about 500, the boiling point is low enough that the conjugate acid can be removed from the polyester composition during the melt-mixing process or after the melt-mixing process. The same is true for other compounds that are generated during the melt-mixing step that might have a deleterious effect on physical properties of the polyester. If the molecular weight of such impurities is below about 500, in general they can be removed during or after the melt-mixing process.

Suitable metal salts useful in the practice of the invention will therefore be salts of conjugate acids having boiling points below about 300° C., preferably below 250° C. and more preferably below 200° C. For example, the boiling points of acetic acid, propionic acid, carbonic acid, benzoic acid, phosphoric acid, hydrochloric acid, hydrogen iodide, hydrogen bromide, iodine, chlorine, and sulfuric acid, are below 200° C. Thus, the use of aqueous solutions of metal salts of fatty acids is not an aspect of the invention.

The anion of the metal salts useful in the invention is preferably a low molecular weight anion such as carbonate or acetate. The anion must be capable of forming a neutral (i.e. not ionized) compound, generally the conjugate acid of the anion, having a molecular weight less than 500. Examples of such acids include, for example, acetic acid, which is the conjugate acid of the acetate anion, and carbonic acid, which is the conjugate acid of the carbonate anion. Neutral compounds formed during the melt-mixing process of the invention are preferably removed from the polyester composition during the melt-mixing process step of the invention, rather than after isolation of the moldable polyester composition. For example, in an embodiment wherein sodium acetate is used, some of the sodium acetate will react during the melt-mixing process to form acetic acid which is volatile enough to be removed from the polyester composition during melt-mixing. Sodium carbonate can react to form carbonic acid which decomposes to CO₂ and water during melt-mixing. The CO₂ and water can be easily removed during the melt-mixing step.

The molecular weight of the anion of the metal salt useful in the practice of the invention is 500 or less, preferably less than 300, more preferably less than 200, even more preferably less than 150, and most preferably less than 100.

Because of their low molecular weights, the neutral compounds (i.e. other than metal salts) that are generated from the anion of the metal salt during the melt-mixing process step will have low enough boiling points or vapor pressures so they will be easily removed from the polymer melt during the melt-mixing step of the process of the invention. The resultant moldable polyester composition that is obtained after isolation comprises low concentrations of the neutral compounds. Preferably, the degree of removal of these undesirable neutral compounds is such that the concentration of neutral compounds in the isolated polyester compositions prepared by the process of the invention will be below 10% by weight, preferably below 1% by weight of the polyester composition, based on the total weight of all components comprising the moldable polyester composition.

Anions of the metal salts useful in the invention may or may not contain carbon atoms. If the anion contains carbon atoms, it is preferred the anion contain no more than 6 carbon atoms. If the anion is aliphatic, more preferably the anion will contain less than or equal to 5 carbon atoms, even more preferably less than or equal to 4 carbon atoms, and most preferrably less than or equal to 3 carbon atoms. If the anion contains an aromatic functionality, then the number of carbon atoms is preferably less than 9, more preferably less than 8 carbon atoms. Non-limiting examples of anions that contain carbon atoms include acetate, propionate, butyrate, isobutyrate, carbonate and benzoate anions. Inorganic anions include phosphate, bromide, chloride, fluoride, iodide, nitrate, and hydroxyl anions, and their derivatives (for example hydrogen phosphate). Preferably the metal salt is a salt of a C₁-C₃ carboxylic acid. Preferred organic anions are carbonate and acetate anions.

Conjugate acids of metal salts based on fatty acids, i.e. a C₁₂-C₃₀ fatty acid (e.g., stearic acid), have boiling points too high to be removed during the melt-mixing step of the inventive process. If metal salts of such acids were used to form aqueous solutions that are melt-mixed with the polyester in the process of the invention, the resulting polyester would contain fatty acid residues in concentrations that could adversely affect polymer physical properties, which is undesirable.

Non-limiting examples of metal salts useful in the preparation of the aqueous solutions of the invention include sodium acetate, sodium carbonate, potassium acetate, potassium carbonate, sodium formate, and potassium formate. Metal salts that comprise sodium or potassium cations are preferred.

According to the process of the invention aqueous solutions of metal salts, as defined hereinabove, are melt-mixed with the polyester polymer. Melt-mixing of metal salts in solid form with polyester polymers is not an aspect of the invention. The addition of solid metal salts to polyesters has several disadvantages. First, group 1A metal salts typically have melting points above the melting point of the polyester to which the salts are added. Consequently, the solid salts, when dispersed in molten polyester will remain in the solid state and not melt. Therefore, preparation of homogeneous dispersions can become difficult. Also, the addition of only a few percent by weight of solid metal salts to polyester polymers can increase the viscosity of the polyester polymer to extremely high levels making processing of these viscous materials difficult and energy intensive.

Aqueous metal salt solutions for use in processes of the invention are prepared by completely dissolving the solid metal salt in water. The method used to prepare the aqueous metal salt solutions is not particularly limited. The solid salt can be added to water or the water to the solid salt using common mixing methods known in the art. The concentration of metal salt in the aqueous solution is from about 0.5% to 80% by weight, preferably 10% to 80% by weight, more preferably 20% to 80% by weight, and most preferably 20% to 60% based on the weight of the salt and water. It is preferable that the concentration of metal salt in water be as high as possible so that the amount of water that must be removed during the melt-mixing step is minimized. Typically, as the temperature of the water is increased, the amount of metal salt that can be dissolved in the aqueous solution is also increased. It is preferred that the temperature of the aqueous metal salt solution which is added to the polyester melt is from about 30° C. to 90° C., preferably 40° C. to 80° C.

Depending on the concentration of the metal salt in the aqueous metal salt solution, the actual concentration of metal salt in the polyester composition, after removal of the water from the melt-mixed polyester composition will be less than the weight of aqueous metal salt solution added to the polyester polymer. For example, if 100 grams of an aqueous metal salt solution contains 30% by weight sodium carbonate and is added to 100 grams of polyester polymer, then the concentration of solid sodium carbonate in the polyester composition, after melt-mixing the aqueous metal salt solution with the polyester polymer and complete water removal, will be 30 grams in 130 grams of polyester composition or 23% by weight of the metal salt and polyester polymer.

The aqueous solution of metal salts is melt-mixed with one or more polyester polymers by the processes of the invention to prepare moldable polyester compositions. The volume of aqueous solution of metal salt(s) added to the polyester melt composition during melt-mixing is determined by the concentration of metal salt in the aqueous solution and the desired concentration of metal salt in the isolated moldable polyester composition. The concentration of metal salt in the isolated moldable polyester composition is the weight of metal salt in the polyester composition, based on the total weight of the salt plus polyester after removal of water from the composition. The concentration of metal salt in the isolated polymer composition is from about 0.05% to 20% by weight, preferably 0.15% to 15% by weight, based on the total weight of the salt and polyester.

### Melt-Mixing and Isolation of Moldable Polyester Composition

Polyester compositions prepared by the process of the invention are melt-mixed blends, wherein all of the polymeric components are well-dispersed within each other and all of the non-polymeric ingredients are well-dispersed throughout the polymeric components to form a homogeneous composition. Any melt-mixing method may be used to combine the polymeric components and non-polymeric ingredients useful in the present invention so long as the melt-mixing method permits removal of residual water from the polyester composition during or after the melt-mixing process. It is preferred that the residual water be removed during the melt-mixing operation but residual water may also be removed after cooling or isolation of the polyester polymer and the aqueous metal salt. For example, one method of removing residual water from the isolated moldable polyester composition comprises applying dehumidified air to the polyester composition. Alternatively, a portion of the residual water may be removed during the melt-mixing operation and the remainder removed after the melt-mixing operation is complete or after isolation of the melt-mixed blend, for example after exit through an extruder die. Such operations are within the skill of one knowledgeable in the art.

Preferably, after completion of the melt-mixing step of the process of the invention the amount of residual water present in the polyester composition will be less than 5 wt %, more preferably less than 2 wt % and most preferably less than 1 wt % water, wherein the weight percentages are based on the total weight of the salt and polyesters.

In certain embodiments the polyester polymer, aqueous metal salt(s) solution, and any optional ingredients may be added to a melt mixer, such as a single or twin-screw extruder; a blender; a single or twin-screw kneader; or a Banbury mixer, either simultaneously through a single step addition, or in a stepwise fashion, and then melt-mixed. When the polyester polymer and the metal salt(s) solution are added in a stepwise fashion, a portion of the polyester polymer and/or the metal salt(s) solution are added to the mixing equipment in an initial operation and then melt-mixed, with the remaining polyester polymer and metal salt solution(s) subsequently added. The resultant composition is further melt-mixed until a well mixed, homogeneous, composition is obtained. A homogeneous composition is a composition that has a uniform composition throughout the material. In other words, a homogeneous composition is one in which any part or portion of the composition will have the same composition as any other portion or part of the composition. Preferably, an extruder, and more preferably, a twin-screw extruder, will be used as the melt-mixing device for forming the moldable polyester compositions. The extruder comprises a vent port and more preferably a vacuum vent port, or other means to remove the residual water from the polyester composition.

When the melt-mixing processes of the present invention are used, polyester compositions are obtained wherein the melt flow rate (MFR) of the polyester composition is decreased by at least 15 percent relative to the MFR of polyester compositions prepared by melt-mixing solid metal salts with polyester polymers at equivalent salt levels. This 15 percent decrease in MFR is observed when the salt levels on a solids basis are equal to about 0.5 percent to about 20 percent, preferably about 0.6 to about 15 weight percent, and more preferably 0.6 percent to 10 percent by weight of the polyester composition. Percentages are based on the total weight of the polyester and metal salt in the polyester composition (i.e. on a solids basis). A decrease in MFR (lower numerical value) represents an increase in melt viscosity of the polyester compositions. Increased (i.e. higher) melt viscosity is preferred during extrusion molding and blow molding processes where the molten polymer must maintain its shape after exiting the extruder or blow molding die before cooling. If the viscosity is too low (higher numerical value), the extruded polymer may sag or deform before cooling and hardening into its molded shape.

Without being bound by theory, it is believed the water in the aqueous metal salt solution acts as a carrier for the metal salt and allows for easier and more homogeneous dispersion of the metal salt into the polyester polymer and allows for incorporation of higher loading levels of metal salts into the polyester polymer compared to addition of solid metal salts.

The DMA storage modulus (23° C.) of polyester compositions prepared by the processes of the invention using aqueous solutions of metal salts is superior to the DMA storage modulus of polyester compositions prepared using solid metal salts at equivalent salt levels when the salt levels are about equal to or greater than 3 weight percent to about 20 weight percent on a solids basis, i.e. 3 weight percent to 20 weight percent salt, based on the weight of the polyester plus salt. Preferably, the quantity of metal salt in the polyester compositions prepared by the process of the invention is equal to or greater than about 3 to about 15 weight percent, based on the weight of salt plus polyester and most preferably from about 4 to about 12 weight percent based on the weight of salt plus polyester. The improvement in DMA storage modulus of compositions prepared by the processes of the invention compared with compositions prepared by the addition of solid metal salts to a polyester melt is a property that characterizes certain compositions prepared by the process of the invention. Polyester compositions prepared using the same solid metal salt(s) (i.e. added to the polyester as a solid and not as an aqueous solution) and at equivalent loading levels of salt on a solids basis (i.e. wherein the weight of the salt plus polyester is the same), do not achieve the improvement in DMA storage modulus of polyester compositions of the invention. Such comparison of DMA storage modulus values of polyester compositions is based on equivalent levels of the same metal salt in the polyester compositions being compared. That is, for example, if the metal salt used in the aqueous solution is sodium acetate, then sodium acetate is used as the solid metal salt for comparison purposes. The improvement (higher numerical value) in DMA storage modulus is at least 10 percent greater for polyester compositions prepared by melt-mixing using the process of the invention compared to the improvement in DMA storage modulus of polyester compositions prepared by melt-mixing using solid metal salts. The percentage improvement is relative to the DMA storage modulus of the polyester composition comprising no metal salt.

DMA storage modulus is related to polymer stiffness properties. The higher the numerical value of DMA storage modulus, the better will be the ability to store energy under load during use of the polymer. It has surprisingly been found that the improvements to DMA storage modulus and melt flow rate conferred by addition of aqueous solutions of metal salts during the melt-mixing process do not extend to compositions wherein the substrate copolyetheresters have Shore D hardness values of less than 40 D, e.g. Shore D hardness of 30 D. Processes of the prior art wherein solid metal salts are blended with polyetheresters do not disclose or predict this effect.

In certain embodiments, the light transmittance of the moldable polyester compositions prepared by the processes of the invention, wherein the salts that are melt-mixed with the polyester polymer are in the form of aqueous solutions, is superior to the light transmittance of polyester compositions prepared by melt-mixing the polyester polymer with equivalent levels of solid metal salts. That is, when the weight of salt in the moldable polyester composition is about equal to or greater than 0.05 weight percent to about 10 weight percent, based on the weight of the polyester and salt, the light transmittance of the moldable composition is enhanced significantly versus that of a similar composition having the same weight percentage salt, based on the weight of the polyester plus salt, wherein the salt is in the form of a solid when melt-mixed with the polyester and wherein the Shore D hardness of the polyester is 50 D or greater. Preferably, the quantity of metal salt in the polyester composition in embodiments where enhanced light transmittance is desired is equal to or greater than about 0.10 to about 8 weight percent, and more preferably from 0.20 weight percent to 5 weight percent, the weight percentages being based on the total combined weight of the metal salt and polyester. The improvement in light transmittance of compositions prepared by the processes of the invention compared with compositions prepared by addition of solid metal salts to polyester is an additional property that characterizes polyester compositions prepared in certain embodiments of the invention. Polyester compositions prepared by a melt-mixing process wherein a metal salt is added to the polyester in the form of a solid and not in the form of an aqueous solution, at equivalent loading levels of salt (based on the weight of the polyester plus salt) do not achieve the improvement in light transmittance that characterizes the above-described embodiments of the polyester compositions prepared by the processes of the invention. Such comparison of light transmittance values of polyester compositions is based on equivalent levels of metal salt in the polyester compositions being compared. The improvement (high numerical value) in light transmittance is at least 20 percent greater for polyester compositions prepared by the processes of the invention than the improvement in light transmittance of polyester compositions prepared by a process wherein the metal salt is added as a solid to the polymer that is being melt-mixed when the concentration of metal salt in the polyester is 0.05 weight percent to about 10 weight percent and the polyester has a Shore D hardness of about 50 D or greater.

When the polyester used in the process of the invention to prepare the polyester composition has a Shore D hardness of about 45 D or greater, the improvement in light transmittance of the polyester composition relative to a polyester composition without metal salt, occurs when the concentration of metal salt in the polyester composition, on a solids basis, is above about 0.15 weight percent to about 10 weight percent.

When polyester polymer/metal salt blends are prepared by melt-mixing the polyester polymer with solid metal salts, rather than an aqueous metal salt solution as in the present invention, at equivalent loading levels of the same salt on a solids basis (i.e. the weight percentage of salt in the polyester composition is the same, based on the weight of the salt plus polyester in the absence of water), they typically do not exhibit the high flexural modulus values of the polyester compositions of the invention. Typically, improvement in flexural modulus values of at least 10 percent will be obtained when the metal salt is added as an aqueous solution at metal salt concentrations (solids basis) above about 4 weight percent to about 15 weight percent when compared to the same composition wherein a solid metal salt is added. Percentages are based on the total combined weight of the polyester and metal salt (solids basis).

Additionally, in certain embodiments, polyester compositions prepared by the processes of the invention may exhibit a decrease in glass transition temperature up to about 5° C. relative to the glass transition temperature of polyester compositions not comprising metal salts added by the inventive process. Consequently, the melt-mixed compositions prepared by the process of the invention are stiff, but do not sacrifice low temperature flexibility. As a consequence, such compositions are particularly suitable for many applications where exposure to low temperatures is possible.

The melt-mixed compositions described herein may further comprise one or more heat stabilizers, antioxidants, fillers and other commonly used additives for polyesters. Examples of suitable heat stabilizers and antioxidants include diphenylamines, amides, thioesters, phenolic antioxidants, and phosphites. When used, the heat stabilizer or antioxidant is preferably present in the composition in an amount of from 0.01 to 5 weight percent, more preferably from 0.01 to at or about 2 weight percent, based on the total weight of the sum of the polyester and the metal salt.

In certain instances, the melt-mixed compositions described herein may be used to prepare compositions for use in manufacture of articles wherein it is useful to incorporate one or more salts of fatty acids. Such would be the case when such compounds do not adversely affect physical properties of the polyester in an end-use application, for example in manufacture of frictional parts, such as plastic gears. When fatty acid salts are added they will be added at a point during manufacture after removal of the residual water from the melt-mixed polyester/metal salt blend. This may be after isolation of the solid polymer. Fatty acids comprise a chain of alkyl groups that contains from about 12 to about 80 carbon atoms and has a terminal methyl group and a terminal carboxyl group. Fatty acids can be saturated, unsaturated or multi-unsaturated fatty acids. Examples of suitable salts of fatty acids include, but are not limited to, salts of pelargonic acid, lauric acid, myristic acid, palmitic acid, margaric acid, stearic acid, oleic acid, arachidic acid, behenic acid, lignoceric acid, cerotic acid, montanic acid, and melissic acid, with the salt of stearic acid and of montanic acid being preferred. The one or more salts of fatty acids are preferably sodium or calcium salts of fatty acids. When used, the one or more salts of fatty acids are from 0.1 to 10 weight percent of the of the total weight of the melt-mixed composition.

Additional additives include one or more of the following components as well as combinations of these: lubricants, UV light stabilizers, antistatic agents, coloring agents, fillers and reinforcing agents, flame retardants, impact modifiers, viscosity modifiers, nucleating agents and other processing aids known in the polymer compounding art. When used, additional additives are generally present in amounts of from about 0.1 to about 50 weight percent of the total weight of the melt-mixed composition.

The additives described herein may be present in these amounts and in physical forms known in the art, including in the form of so-called nano-materials where at least one of the dimensions of the particles is in the range of 1 to 1000 nm.

Polyester compositions prepared by the inventive processes are useful for making a large variety of articles such as airbag deployment doors for automobiles, plastic gears for use in automotive window motors, windshield wiper motors, seat adjuster motors, or other automotive electric motors, as well as rail pads, and jounce bumpers. They are also useful as components in hydraulic hose applications.

Thus, also described herein are processes of making an article comprising a step of shaping the melt-mixed compositions described herein. As used herein, the term “shaping” refers to any technique that imparts form to an article and comprises extrusion, extrusion coating, injection molding, compression molding or blow molding. Preferably, shaping is conducted using a melt extrusion process including blow molding, which is preferred, profile extrusion and corrugated extrusion.

Profile extrusion and corrugated extrusion are conventional techniques of making hollow plastic articles of arbitrary lengths. In both, the composition is extruded in a hot moldable state through the gap between the pin and the die of an extrusion head.

In profile extrusion, a hollow article is made having the same cross section over a long length. The pin and die are shaped to produce the desired cross section. For example, an annular die gap between the concentric circular pin and die is used to make tubes and pipes. After exiting the die assembly, the melt may be drawn to a thinner cross section through an air gap, then cooled and the shape maintained, which results, upon solidification, in an extruded hollow body.

Thus, as described above, the polyester compositions prepared by the processes described herein may be advantageously used for molding shaped articles, especially by blow molding, injection molding, compression molding, or other molding methods known to those skilled in the art. The use of the polyester compositions results in molding operations that are more efficient due to the improved melt rheology imparted by the use of aqueous salt solutions in the melt-mixing process. The use of the polyester compositions prepared by the processes described herein is especially adapted to molding articles such as automotive airbag deployment doors, plastic gears, rail pads, jounce bumpers, CVJ boots and hydraulic hoses, among others.

The invention is further illustrated by the following examples, wherein all parts are by weight unless otherwise indicated.

### EXAMPLES

### Materials Used

The materials listed below were used to prepare the compositions of the examples (E1-E19) and the comparative examples (C1-C18). Comparative example compositions C1, C4, C6 and C7 contain only polyester elastomers and are control compositions.

PE-1: a very low modulus thermoplastic polyester elastomer having a melting point of 177° C. (ISO 11357-1/-3), a melt flow rate (190° C., 2.16 kg) of 5.0 g/10 min. and a nominal Shore D durometer hardness of 30 D, available as Hytrel® 3078 copolyetherester elastomer from E.I. du Pont de Nemours and Company, Wilmington, Del., USA.
PE-2: a medium modulus thermoplastic polyester elastomer having a melting point of 193° C. (ISO 11357-1/-3), a melt flow rate (230° C., 2.16 kg) of 21 g/10 min. and a nominal Shore D durometer hardness of 45 D, available as Hytrel® 4556 copolyetherester elastomer from E.I. du Pont de Nemours and Company, Wilmington, Del., USA.
PE-3: a medium modulus thermoplastic polyester elastomer having a melting point of 203° C. (ISO 11357-1/-3), a melt flow rate (230° C., 2.16 kg) of 8.1 g/10 min. and a nominal Shore D durometer hardness of 55 D, available as Hytrel® 5556 copolyetherester elastomer from E.I. du Pont de Nemours and Company, Wilmington, Del., USA.
PE-4: a medium modulus thermoplastic polyester elastomer having a melting point of 211° C. (ISO 11359-1/-2), a melt flow rate (230° C., 2.16 kg (ISO 1133)) of 9 g/10 min. and a nominal Shore D durometer hardness of 63 D, available as Hytrel® 6356 copolyetherester elastomer from E.I. du Pont de Nemours and Company, Wilmington, Del., USA.
PE-5: a medium modulus thermoplastic polyester elastomer having a melting point of 211° C. (ISO 11359-1/-2), a melt flow rate (230° C., 2.16 kg (ISO 1133)) of 1.4 g/10 min. and a nominal Shore D durometer hardness of 63 D, available as Hytrel® 6386 copolyetherester elastomer from E.I. du Pont de Nemours and Company, Wilmington, Del., USA. Sodium Carbonate, available from Mallinckrodt Baker Inc. Sodium Acetate, commercially available from Sigma-Aldrich Co. Sodium Bicarbonate, commercially available from Mallinckrodt Baker Inc. Potassium Carbonate, commercially available from Sigma-Aldrich Co. Zinc Acetate, commercially available from Sigma-Aldrich Co.
Ionomer: a copolymer comprising copolymerized units of ethylene and 11 weight percent methacrylic acid, wherein approximately 58% of the available carboxylic acid moieties are neutralized with sodium cations.
All metal salts used in the examples are in anhydrous form.

Aqueous solutions of the metal salts used in the examples were prepared by completely dissolving the metal salt in water. The solid metal salt was added into deionized water in a glass vessel and the solution stirred until the metal salt was completely dissolved in the water and a clear solution was obtained.

The aqueous solution of sodium acetate was prepared by completely dissolving 33.3 grams of sodium acetate in 100 grams of water. The aqueous solution A of sodium carbonate was prepared by completely dissolving 25 grams of sodium carbonate in 100 grams of water. The aqueous solution B of sodium carbonate was prepared by completely dissolving 5.26 grams of sodium carbonate in 100 grams of water. The aqueous solution of potassium carbonate was prepared by completely dissolving 75 grams of potassium carbonate in 100 grams of water. The aqueous solution of zinc acetate was prepared by completely dissolving 33.3 grams of zinc acetate in 100 grams of water. These aqueous solutions were used for the examples in Tables 1 to 7.

The quantity of metal salt on a solids basis in the polyester composition of the invention was calculated from the amount of salt dissolved in the aqueous solution. In Table 1 example E1 has 10 weight percent of an aqueous potassium carbonate solution added to the polyester polymer. Since 10 grams of aqueous potassium carbonate solution contains 4.29 grams of salt on a solids basis (75 g/175 g=42.9 wt % potassium carbonate in the aqueous solution) the weight percent of metal salt added to the polyester polymer on a solids basis is 4.29. The weight percent of metal salt in the final moldable polyester composition is based on the weight percent of polyester and metal salt. For E1, the weight percent of metal salt in the moldable polyester composition is 4.29/(90+4.29) or 4.55% by weight based on the weight of the metal salt and the polyester polymer and is listed as wt % salt in MPC (Moldable Polyester Composition).

All materials listed for the compositions in Tables 1-7 are in grams unless indicated otherwise.

### Sample Preparation

### Melt-Mixing Procedure

The compositions of Examples E1-E19 and Comparative Examples C6-C18 were prepared by melt-mixing the ingredients shown in Tables 1 to 4-in a 30 mm twin screw extruder. The extruder was fitted with a vacuum vent port in the barrel. Compositions comprising copolyester thermoplastic elastomers were prepared in the extruder under conditions such that the barrel temperature was set at approximately 250° C. This provided a polymer melt when the extruder was operated at a screw speed of about 250 rpm. Aqueous metal salt solutions were heated to approximately 50° C. prior to addition to the polymer melt.

All solid ingredients were introduced through a feed throat in the first barrel and aqueous metal salt solutions were injected through an injection port in the fifth barrel. The melt temperature of the resin composition, as measured with a hand-held probe, was approximately 265° C. as it exited the die. Upon exiting the extruder, the compounded mixtures were extruded in the form of laces or strands, cooled, chopped into granules and then placed into sealed aluminum lined bags in order to prevent moisture pick-up. Ingredient quantities shown in Table 1 are given in weight percent on the basis of the total weight of the ingredients before melt-mixing occurred.

The compositions of Examples E20-E36 and Comparative Examples C19-C26 were prepared by melt-mixing the ingredients shown in Tables 5 and 6 using the same melt-mixing method described above except the barrel temperature of the extruder was approximately 260° C.

### Test Procedures

### Melt Flow Rate (MFR)

Melt flow rate was measured using an Extrusion Plastometer MP 987 instrument available from Tinius Olsen Material Testing Machine Company on pellets according to the method of International Standard ISO 1133. MFR of the compositions of all examples and comparative examples were measured at 230° C. under a 2.16 kg load except for examples and comparative examples that contained PE1. A temperature of 190° C. under a 2.16 kg load was used for all the examples and comparative examples that contained PE1 as a component.

Prior to determination of melt flow rate, the granules were dried under vacuum with a nitrogen purge for 12 hours at 80° C. Tables 1 to 3 present average MFR values obtained from two sample specimens. The values of MFR are reported in grams/10 minutes. Melt flow rate is also commonly referred to as melt flow index.

### Flexural Modulus

Flexural modulus was determined according to ISO 178.

### DMA Storage Modulus

DMA Storage modulus was determined on injection molded test specimens. The dimensions of the test specimen mold cavity were 135.35 mm (length), 12.89 mm (width) and 3.23 mm (depth). Mold temperature was maintained at 45-55° C. Molding melt temperatures of the compositions were in the range of 245 to 265° C. The test specimens were cut to a length of 60 mm after injection molding. DMA measurements were performed according to ISO 6721-5 using a TA Instruments model DMA Q800 instrument. The test specimens were clamped onto a 35 mm dual cantilever clamp to provide a 17.5 mm distance between the center and end clamps. The storage modulus measurement was determined using a frequency selected from a range of 1 to 20 Hz, over a temperature range of −145° C. to +170° C. with a 2.0° C./minute ramp rate. Storage modulus at 23° C. (E′₂₃) and 100° C. (E′₁₀₀) was determined. The percent retention of storage modulus can be calculated using the ratio E′₁₀₀/E′₂₃×100.

### Shore D Hardness

Shore D Hardness was measured according to ISO 868.

### Average Light Transmittance

Average light transmittance was determined by testing injection molded test plaques. Test plaques were made by injection molding pellets prepared by the melt mixing method described above using a 30 mm twin-screw extruder and a mold with nominal cavity dimensions of 76.2 mm (length) by 76.2 mm (width) by 1.59 mm±0.025 mm (thickness). Mold temperature was maintained at 45-55° C. Molding melt temperatures of the compositions were in the range of 220 to 250° C.

Average light transmittance of the test plaques was measured according to a modified ASTM D1003B method using a GretagMacbeth Color-Eye® 7000A spectrophotometer available from GretagMacbeth Corporation, New Windsor, N.Y., USA. The wavelength of light used to test light transmittance of the test plaques ranged from 360 nm to 750 nm at 10 nm intervals. Thus, light transmittance measurements were taken at 360 nm, 370 nm, 380 nm, up to 750 nm. The spectrophotometer measures a total transmission (in percent) at each wave length, for example, 10% at 360 nm, 12% at 370 nm, 15% at 380 nm, up to 750 nm. The percent transmittance at each wavelength was measured by the spectrophotometer to obtain 40 measurements or data points for each test plaque. The 40 measurements were then averaged to obtain the average transmittance shown in Tables 1-6.

### Glass Transition Temperature

Glass transition temperature (Tg) was determined on injection molded test specimens of the same dimensions as those used for DMA storage modulus measurement. Properties of the test specimens were measured using dynamic mechanical analysis according to ISO method 6721-5, at a frequency of 1 Hz, and a temperature scan rate of 2° C./min. The glass transition point was considered the apex of the tan delta peak.

### EXAMPLES AND COMPARATIVE EXAMPLES

The data shown in Tables 1 to 7 were generated using the preparation methods and test methods described above. The data permit comparison of physical properties of a) polyester compositions comprising metal salts that have been added to polyester compositions by the processes of the invention (i.e. wherein aqueous metal salt solutions are added to the polyesters) (Examples)) to b) polyester compositions comprising metal salts wherein a solid salt is added to the polyester compositions (Comparative Examples). With respect to the Examples, the percent salt (solids basis) represents the amount by weight of metal salt added to the polyester polymer. The wt % salt in MPC shown in the tables represents the weight percent of metal salt in the final moldable polyester composition after removal of the water and based on the total weight of polyester polymer and metal salt (solids basis). For the Comparative Examples that contain salts added as solids, the percent salt (solids basis) represents the weight percent of solid or dry metal salt added to the polyester composition.

### Examples E1-E19 and Comparative Examples C1-C18

Examples E1-E2 (Table 1) and E9-E19 (Tables 3 and 4) and Comparative Examples C4 and C8-C18 (Tables 1, 3 and 4) contain PE3 as the thermoplastic polyester elastomer component. The C4 composition contains PE3 in the absence of additives or salts. The data shown indicate that the addition of metal salts to polyester compositions using the process of the invention results in modification of at least two physical properties of the polyester compositions, specifically MFR and DMA storage modulus.

The results indicate that for the samples tested, at greater than or equal to about 3 weight percent to about 8 weight percent salt on a solids basis (i.e. based on the total weight of salt plus polyester) (E12-E14 (Table 3) and E18-E19 (Table 4)), the storage moduli (23° C.) of the polyester compositions of the invention are at least 10 percent greater than the DMA storage moduli of polyester compositions comprising an equivalent quantity of metal salt (C8-C12 (Table 3) and C14-C15 (Table 4)) which was melt-mixed into the polyester composition in solid form. A similar effect is observed for E12-E13. The percent improvement is relative to the DMA storage modulus of a polyester composition comprising no (i.e. zero percent) metal salt.

The data in the tables also illustrate the effect that addition of aqueous metal salts vs. addition of solid salts has on the MFR of polyester compositions. See for example the data for E4 vs. C5 in Table 1, E13 vs. C9 in Table 3, E14 vs. C10 in Table 3, E17 vs. C13 in Table 4, E18 vs. C14 in Table 4 and E19 vs. C15 in Table 4.

Comparative examples C2 and C3 (Table 1) illustrate that if the Shore D hardness of the polyester is less than about 40 D, addition of aqueous solutions of metal salts to the polyester imparts little if any improvement in storage modulus and flexural modulus to the polyester composition. The MFR of the polyester compositions decreases when aqueous metal salts are added to the polyester at approximately 4.3 percent salt on solids basis, but at approximately 8.5 percent salt, the MFR actually increases.

Comparative Example C18 (Table 4) is an example of a composition prepared by the addition of an aqueous divalent metal salt solution to polyester PE-3. The amount of metal salt added on a solids basis is about 2.5 wt %. Example E11 (Table 3) contains 2.5 wt % monovalent metal salt (solids basis) added in an aqueous solution. The MFR of the example E11 composition is considerably less than that of the C18 composition. The same polyester and the same quantity of salt added as an aqueous solution are used in both cases. The DMA storage modulus of E11 is more than 10% higher than that of the C18 composition. Flexural modulus is also superior in the E11 composition compared to the C18 composition. The only difference between E11 and C18 is that a monovalent cation salt is present in the E11 composition and a divalent cation salt is present in the C18 composition. The anion of the salts present in E11 and C18 is the same (acetate). This indicates that addition of carboxylic acid salts having monovalent metal cations to polyester compositions according to the processes of the invention results in a greater improvement to MFR, DMA storage modulus and flexural modulus of the polyester compositions than the addition of salts of carboxylic acid having divalent cations.

TABLE 1

| | C1 | C2 | C3 | C4 | E1 | E2 | C5 | C6 | C25 | E3 | E4 |
|---|---|---|---|---|---|---|---|---|---|---|---|
| PE1 | 100 | 90 | 80 | | | | | | | | |
| PE3 | | | | 100 | 90 | 80 | 95.7 | | | | |
| PE4 | | | | | | | | 100 | 99 | 90 | 80 |
| K₂CO₃ soln. | | 10 | 20 | | 10 | 20 | | | | 10 | 20 |
| K₂CO₃ solid | | | | | | | 4.3 | | | | |
| Na Stearate (powder) | | | | | | | | | 1 | | |
| salt (solids basis) | 0 | 4.29 | 8.57 | 0 | 4.29 | 8.57 | 4.3 | 0 | 1 | 4.29 | 8.57 |
| Wt % salt in MPC¹ | 0 | 4.55 | 9.68 | 0 | 4.55 | 9.68 | 4.3 | 0 | 1 | 4.55 | 9.68 |
| Physical Properties | | | | | | | | | | | |
| MFR 2.16 Kg | 5 | 0.42 | 7.2 | 18.9 | 2.4 | 1.5 | 2.9 | 8.5 | 21.7 | 0.34 | 0.21 |
| MFR vs. C1 (% decrease) | — | 84 | (44)² | — | — | — | — | — | — | — | — |
| MFR vs. C4 (% decrease) | — | — | — | — | 87 | 92 | 85 | — | — | — | — |
| MFR vs. C6 (% decrease) | — | — | — | — | — | — | — | — | (155)² | 96 | 98 |
| Flex Modulus (MPa) | 28 | 20.7 | 23.9 | 174 | 250 | 315 | 255 | 300 | N.M. | 401 | 443 |
| DMA Storage Modulus | 20.6 | 21.3 | 24.3 | 203 | 297 | 363 | 274 | 298 | N.M. | 453 | 486 |
| 23° C. (MPa) | | | | | | | | | | | |
| DMA vs. C1 (% increase) | — | 3.4 | 18 | — | — | | | — | — | — | — |
| DMA vs. C4 (% increase) | — | — | — | — | 46 | 79 | 35 | — | — | — | — |
| DMA vs. C6 (% increase) | — | — | — | — | — | — | — | — | N.M. | 52 | 63 |
| T_{g}(° C.)* | 55.7 | 54.3 | 52.2 | 24.3 | 37.9 | 38.8 | 38 | 3.2 | N.M. | 10.4 | 11.9 |

*All Tg values are negative numbers
¹MPC is moldable polyester composition
²Increase

TABLE 2

| | C7 | E5 | E6 | E7 | E8 |
|---|---|---|---|---|---|
| PE2 | 100 | 90 | 80 | 70 | 65 |
| Na acetate soln. | | 10 | 20 | 30 | 35 |
| % salt (solids basis) | 0 | 2.5 | 5 | 7.5 | 8.75 |
| Wt. % salt in MPC | 0 | 2.7 | 5.9 | 9.7 | 11.9 |
| Physical Properties | | | | | |
| MFR | 21 | 4.9 | 6.4 | 6.6 | 6.1 |
| MFR vs. C7 (% decrease) | — | 76 | 70 | 69 | 71 |
| Flex Modulus (MPa) | 83 | 120 | 155 | 178 | 201 |
| DMA Storage Modulus 23° C. (MPa) | 89 | 118 | 147 | 184 | 197 |
| DMA vs. C7 (% increase) | — | 33 | 65 | 107 | 121 |
| T_{g} (° C.)* | 45.5 | 48.9 | 48.4 | 48.4 | 48.9 |

TABLE 3

| | C4 | E9 | E10 | E11 | E12 | E13 | E14 | C8 | C9 | C10 | C11 | C12 |
|---|---|---|---|---|---|---|---|---|---|---|---|---|
| PE3 | 100 | 97 | 95 | 90 | 85 | 80 | 70 | 97.5 | 95 | 92.5 | 95 | 90 |
| Na acetate soln. | | 3 | 5 | 10 | 15 | 20 | 30 | | | | | |
| Na acetate solid | | | | | | | | 2.5 | 5 | 7.5 | | |
| Ionomer | | | | | | | | | | | 5 | 10 |
| % salt (solids basis) | 0 | 0.75 | 1.25 | 2.5 | 3 | 5 | 7.5 | 2.5 | 5 | 7.5 | 5 | 10 |
| Wt % salt in MPC | 0 | 0.77 | 1.3 | 2.7 | 3.4 | 5.9 | 9.7 | 2.5 | 5 | 7.5 | 5 | 10 |
| Physical Properties | | | | | | | | | | | | |
| MFR 2.16 Kg | 18.9 | 3 | 1 | 0.39 | 0.2 | 0.2 | 0.1 | 7.3 | 6 | 4.6 | 6.2 | 1.3 |
| MFR vs. C4 (% decrease) | — | 84 | 94 | 98 | 99 | 99 | 99.5 | 61 | 68 | 76 | 67 | 93 |
| Flex Modulus (MPa) | 174 | 173 | 202 | 211 | 288 | 337 | 400 | 233 | 278 | 306 | 189 | 191 |
| DMA Storage Modulus 23° C. (MPa) | 203 | 212 | 219 | 251 | 299 | 300 | 405 | 243 | 267 | 287 | 207 | 205 |
| DMA vs. C4 (% increase) | — | 4.4 | 7.9 | 24 | 47 | 47 | 100 | 20 | 32 | 41 | 2 | 1 |
| T_{g}(° C.)* | 24.3 | 28 | 29.3 | 31 | 32.2 | 30.9 | 29.6 | 30.1 | 29.7 | 28.6 | 28.7 | 27.2 |

All Tg values are negative numbers.

TABLE 4

| | E15 | E16 | E17 | E18 | E19 | C13 | C14 | C15 | C4 | C16 | C17 | C18 |
|---|---|---|---|---|---|---|---|---|---|---|---|---|
| PE3 | 97 | 95 | 90 | 80 | 70 | 98 | 96 | 94 | 100 | 97 | 95 | 90 |
| Na₂CO₃ soln. | 3 | 5 | 10 | 20 | 30 | | | | | | | |
| Na₂CO₃ solid | | | | | | 2 | 4 | 6 | | | | |
| Na₂HCO₃ solid | | | | | | | | | | 3 | 5 | |
| Zn acetate soln. | | | | | | | | | | | | 10 |
| % salt (solids basis) | 0.6 | 1 | 2 | 4 | 6 | 2 | 4 | 6 | 0 | 3 | 5 | 2.5 |
| Wt % salt in MPC | 0.61 | 1.04 | 2.2 | 4.8 | 7.9 | 2 | 4 | 6 | 0 | 3 | 5 | |
| Physical Properties | | | | | | | | | | | | |
| MFR | 11.8 | 0.4 | 0.1 | 0.4 | 0.5 | 3.3 | 2.4 | 2.4 | 18.9 | 0.48 | 0.3 | 25 |
| MFR vs. C4 (% decrease) | 38 | 98 | 99.5 | 98 | 97.5 | 86 | 87 | 87 | — | 97.5 | 98 | (32)² |
| Flex Modulus (MPa) | 175 | 185 | 215 | 237 | 265 | 202 | 206 | 227 | 174 | 165 | 190 | 202 |
| DMA Storage Modulus 23° C. (MPa) | 216 | 196 | 207 | 251 | 296 | 221 | 236 | 240 | 203 | 170 | 211 | 223 |
| DMA vs. C4 (% increase) | 6.4 | (3.5)¹ | 2 | 24 | 46 | 8.9 | 63 | 18 | — | (16)¹ | 3.9 | 9.9 |
| T_{g}(° C.)* | 26.9 | 28.1 | 30.2 | 30 | 31.9 | 31.2 | 29 | 30.9 | 24.3 | 25 | 26.8 | 26.9 |

*All Tg values are negative numbers;
¹decrease
²increase

### Examples E20 to E26 and Comparative Examples C19 to C22

The data in Table 5 illustrates that light transmittance of polyester compositions prepared by the process of the invention having a salt content of 0.13 weight percent, based on the weight of polyester plus salt, is at least 46 percent greater than the light transmittance of the same polyester composition that does not contain metal salt (E24 vs. C19). The Example 23 composition (E23) exhibits a light transmittance value that is 282 percent greater than that of the Comparative Example 22 (C22) composition. The C22 composition was prepared from the same polyester composition as the E23 composition except that the salt was added as a solid to the polyester in C22 vs. as an aqueous solution in E23. The weight percentage of salt was the same, based on the weight of polyester plus salt, for both compositions. Comparative examples C20 and C21 show that the addition of metal salts in aqueous solutions to polyester compositions at levels below about 0.15 weight percent, based on the weight of polyester plus salt does not improve the light transmittance of the polyester compositions compared to the control C19 which contains no metal salt when the polyester has a shore D hardness of less than about 50 D. Examples E20 to 23 and E25 to E26 illustrates that metal salt levels above about 0.15 weight percent to about 1 weight percent, based on the weight of polyester plus salt impart significantly higher light transmittance properties to polyester compositions having a shore D hardness of about 45 D or greater and comprising the same level of metal salts, based on the weight of polyester plus salt, but wherein the salt was added to the polyester as a solid metal salt.

TABLE 5

| | C19 | C20 | C21 | E20 | E21 | E22 | E23 | E24 | E25 | E26 | C22 |
|---|---|---|---|---|---|---|---|---|---|---|---|
| PE3 | 100 | 99 | 99.5 | 99 | 98 | 97 | 95 | 99.5 | 99 | 99 | 99 |
| Na acetate soln. | | | | | | | | 0.5 | 1 | | |
| Na carbonate soln. A | | | 0.5 | 1 | 2 | 3 | 5 | | | | |
| Na carbonate soln. B | | 1 | | | | | | | | | |
| K carbonate soln. | | | | | | | | | | 1 | |
| Sodium Stearate (powder) | | | | | | | | | | | 1 |
| Physical Properties | | | | | | | | | | | |
| % salt (solids basis) | 0 | 0.05 | 0.1 | 0.2 | 0.41 | 0.61 | 1.04 | 0.13 | 0.25 | 0.43 | 1 |
| Wt % salt in MPC | 0 | 0.05 | 0.1 | 0.2 | 0.42 | 0.62 | 1.09 | 0.13 | 0.25 | 0.43 | 1 |
| Average Total Light | 11.5 | 5 | 8.5 | 35.5 | 38.6 | 37.3 | 39.5 | 16.9 | 40.1 | 24 | 14 |
| Transmittance (Tₜ) | | | | | | | | | | | |
| Tₜ vs C19 (% change) | — | −56 | −26 | +209 | +235 | +224 | +243 | +47 | +249 | +109 | +22 |
| MFR | 18.9 | N.M | 46.5 | 13.6 | 5.7 | 5.3 | 1.7 | 13 | 14.6 | 7.4 | 27.3 |
| MFR vs. C19 (% decrease) | — | — | (246)¹ | 28 | 70 | 78 | 91 | 31 | 23 | 61 | (44)¹ |

N.M.—not measured;
¹increase

### Examples E27 to E36 and Comparative Examples C23 to C26

The data in Table 6 further confirm the improvement in light transmittance of polyester compositions prepared by the process of the invention. Examples E27-E33 show that when the metal salt is added as an aqueous solution and the metal salt is at a concentration of at least about 0.1 weight percent on a solids basis in the polyester, the light transmittance of the polyester composition is at least 44 percent greater than the control (C23) which comprises no metal salt. Examples E34-E36 have a minimum improvement in light transmittance over the control (C24) of at least 52 percent. Comparative Examples C25 and C26 comprise 1 weight percent salt added as a solid during the melt mixing process. The light transmittance of C25 and C26 is inferior to the light transmittance of examples E27-E36, even though the salt concentration of examples E27-E29 is lower than C25 and C26 based on the weight of polyester plus salt on a solids basis.

TABLE 6

| | C23 | E27 | E28 | E29 | E30 | E31 | E32 | E33 | C24 | E34 | E35 | E36 | C25 | C26 |
|---|---|---|---|---|---|---|---|---|---|---|---|---|---|---|
| PE3 | | | | | | | | | | | | | | |
| PE4 | 100 | 99.5 | 99.5 | 99 | 99.5 | 99 | 90 | 80 | | | | | 99 | |
| PE5 | | | | | | | | | 100 | 99.5 | 99.5 | 99 | | 99 |
| Na acetate soln. | | | 0.5 | 1 | | | | | | | 0.5 | 1 | | |
| Na carbonate soln. A | | 0.5 | | | | | | | | 0.5 | | | | |
| K carbonate soln. | | | | | 0.5 | 1 | 10 | 20 | | | | | | |
| Sodium Stearate (powder) | | | | | | | | | | | | | 1 | 1 |
| Physical Properties | | | | | | | | | | | | | | |
| % salt (solids basis) | 0 | 0.1 | 0.13 | 0.25 | 0.21 | 0.43 | 4.55 | 9.68 | 0 | 0.1 | 0.13 | 0.25 | 1 | 1 |
| Wt % salt in MPC | 0 | 0.1 | 0.13 | 0.25 | 0.21 | 0.43 | 4.81 | 10.79 | 0 | 0.1 | 0.13 | 0.25 | 1 | 1 |
| Average Total Light transmittance (Tₜ) | 10.6 | 19.1 | 15.8 | 31.5 | 15.3 | 17.2 | 27.6 | 22.7 | 9.5 | 15.3 | 14.4 | 26.1 | 12.4 | 13.4 |
| Tₜ vs. C23(% change) | — | 80 | 49 | 197 | 44 | 62 | 160 | 114 | — | 61 | — | — | 17 | — |
| Tₜ vs. C24 (% change) | | | | | | | | | — | 61 | 52 | 274 | | 41 |

### Examples E37 to E40 and Comparative Example C27

The data in Table 7 show the improvement in light transmittance of embodiments wherein polyester compositions having a Shore D hardness of 45 prepared by the process of the invention are compared to the same polyester composition in the absence of metal salt. Light transmittance of Examples E38 to E40 was at least 89 percent greater than that of Comparative Example C27. Example E37 has a metal salt content, based on the weight of polyester plus salt, of 0.10 weight percent and has a light transmittance which is 25 percent less than Comparative Example C27 which contains no metal salt. The data in Table 7 also confirm the decrease in MFR of the polyester composition upon melt mixing of at least 0.5 weight percent of metal salt as an aqueous solution to the polyester polymer.

TABLE 7

| | E37 | E38 | E39 | E40 | C27 |
|---|---|---|---|---|---|
| PE2 | 99.5 | 97 | 95 | 90 | 100 |
| Na carbonate soln. A | 0.5 | 3 | 5 | 10 | |
| Physical Properties | | | | | |
| % salt (solids basis) | 0.1 | 0.61 | 1.04 | 2.17 | 0 |
| Wt % salt in MPC | 0.1 | 0.62 | 1.08 | 2.35 | 0 |
| Average Total Light | 10 | 34 | 31.4 | 25.2 | 13.3 |
| Transmittance (Tₜ) | | | | | |
| Tₜ vs C27 (% change) | (25) | 256 | 236 | 89 | — |
| MFR | 57.1 | 3.8 | 2.1 | 1.2 | 21 |

What is claimed is:

1. A process for forming a moldable polyester composition comprising the steps of
A. melt-mixing a composition comprising
1. a polyester having a Shore D hardness of 40 D or greater as determined according to ISO 868; and
2. at least one aqueous solution comprising a metal salt having a molecular weight of 500 or less, wherein i) the metal salt comprises a group 1A cation and ii) the boiling point of the conjugate acid of the anion of the metal salt is less than 300° C.,
thereby forming a polyester/metal salt mixture, wherein the metal salt is present in the polyester/metal salt mixture in an amount of about 0.05 weight percent to about 20 weight percent based on the total combined weight of the metal salt and the polyester; and
B. removing water and gases from the polyester/metal salt mixture to form a moldable polyester composition.

2. A moldable polyester composition prepared according to the process of claim 1.

3. A moldable polyester composition prepared according to the process of claim 1 wherein the polyester has a Shore D hardness of 50 D or greater and the metal salt is present in the polyester/metal salt mixture in an amount of about 0.05 weight percent to about 10 weight percent, based on the total combined weight of the metal salt and the polyester.

4. A moldable polyester composition of claim 3 wherein the moldable polyester composition is characterized by having an average light transmittance that is i) greater than the average light transmittance of the polyester component of the polyester composition and ii) at least 20% greater than the average light transmittance of a moldable polyester composition prepared according to the process of claim 1 but wherein the polyester/metal salt mixture is formed by melt mixing a polyester and a solid metal salt.

5. A moldable polyester composition prepared according to the process of claim 1 wherein the metal salt is present in the polyester/metal salt mixture in an amount of about 0.5 weight percent to about 20 weight percent, based on the total combined weight of the metal salt and the polyester.

6. A moldable polyester composition prepared according to the process of claim 5 wherein the moldable polyester composition is characterized by having a melt flow rate, determined according to ISO 1133, that is i) less than the melt flow rate of the polyester component of the polyester composition when measured according to ISO 1133 under similar conditions and ii) at least 15% lower than the melt flow rate, when determined according to ISO 1133 under similar conditions, of a moldable polyester composition prepared according to the process of claim 1 but wherein the polyester/metal salt mixture is formed by meltmixing a polyester and the same metal salt wherein the metal salt is in solid form.

7. A moldable polyester composition prepared according to the process of claim 6 wherein the metal salt is present in the polyester/metal salt mixture in an amount of about 3.0 weight percent to about 20 weight percent, based on the total combined weight of the metal salt and the polyester.

8. A moldable polyester composition prepared according to the process of claim 7 wherein the polyester composition is characterized by having a DMA storage modulus, determined according to ISO 6721-5 that is i) greater than the DMA storage modulus of the polyester component of the polyester composition, when determined under similar conditions and ii) at least 10 percent greater than the DMA storage modulus of the polyester component determined according to ISO 6721-5 of a moldable polyester composition prepared according to the process of claim 7 but under conditions wherein the polyester/metal salt mixture is formed by melt-mixing a polyester and the same metal salt wherein the metal salt is in solid form.

9. A process for making a shaped article comprising a polyester, the process comprising the steps of
A. providing a moldable polyester composition formed by the process of claim 1; and
B. forming a shaped article by molding said polyester composition.

10. An article prepared by the process of claim 9.

11. An article of claim 9 in the form of an automotive airbag deployment door, a plastic gear, a rail pad, a CVJ boot, jounce bumper, or a hydraulic hose.

12. A process of claim 1, wherein the polyester is a copolyetherester elastomer.

13. A process of claim 1 wherein the metal salt is a salt of a C₁-C₃ carboxylic acid.

14. A process of claim 1 wherein the metal salt is a carbonate salt.

15. A process of claim 1 wherein the metal salt comprises a sodium cation or a potassium cation.

16. A use of a polyester composition for molding a shaped article, the polyester composition being prepared by the process of
A. melt-mixing a composition comprising
1. a polyester having a Shore D hardness of 40 or greater as determined according to ISO 868; and
2. at least one aqueous solution comprising a metal salt having a molecular weight of 500 or less, wherein i) the metal salt comprises a group 1A cation and ii) the boiling point of the conjugate acid of the anion of the metal salt is less than 300° C.,
thereby forming a polyester/metal salt mixture, wherein the metal salt is present in the polyester/metal salt mixture in an amount of about 0.05 weight percent to about 20 weight percent, based on the total combined weight of the metal salt and the polyester; and
B. removing water and gases from the polyester/metal salt mixture to form a moldable polyester composition.

17. A use of claim 16, wherein the polyester is a copolyetherester elastomer that is a copolymer that has a multiplicity of recurring long-chain ester units and short-chain ester units joined head-to-tail through ester linkages, said long-chain ester units being represented by formula (A): 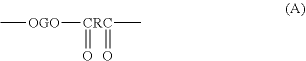
and said short-chain ester units being represented by formula (B): 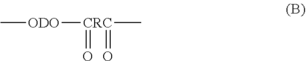
wherein:
G is a divalent radical remaining after the removal of terminal hydroxyl groups from poly(alkylene oxide)glycols having preferably a number average molecular weight of between about 400 and about 6000;
R is a divalent radical remaining after removal of carboxyl groups from a dicarboxylic acid having a molecular weight of less than about 300; and
D is a divalent radical remaining after removal of hydroxyl groups from a diol having a molecular weight preferably less than about 250.

18. A use of claim 16 wherein the shaped article is in the form of an automotive airbag deployment door, a plastic gear, a rail pad, a jounce bumper, a CVJ boot, or a hydraulic hose.
